(19) United States
(12) Patent Application Publication
(10) Pub. No.: US 2009/0142938 A1
(43) Pub. Date: Jun. 4, 2009

(54) Power transfer-connecting device interposed between a power supply and a lamp of a vehicle

(76) Inventor: Alan Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,691

(22) Filed: Dec. 4, 2007

(51) Int. Cl. H01R 33/00

(52) U.S. Cl. 439/34

(57) ABSTRACT

A transfer-connecting device has several sockets at one end, several first terminals at the other end, and several second terminals; the transfer-connecting device is interposed between a power supply and a lamp of a vehicle; the power supply supplies several different voltages through separate power cords; a connecting component is connected to the power cords and the sockets of the transfer-connecting device; the lamp has several terminals, which are connected to the first terminals respectively; the second terminals serve as output passages for the different voltages respectively, which are inputted into the transfer-connecting device through the connecting component; the second terminals are each denoted with a voltage value of electric power to pass through it; when a person is installing an accessory on the vehicle, he can find a correct one of the second terminals for the accessory to be connected and powered with a suitable voltage.

### BACKGROUND OF THE INVENTION

1. Field of the Invention

The present invention relates to a transfer-connecting device of a power supply of a vehicle, more particularly one, which is interposed between the power source and a lamp of the vehicle, and have several terminals to serve as output passages of different voltages respectively, thus allowing the driver of the vehicle to easily and safely connect an accessory to a suitable voltage in installing the accessory.

2. Brief Description of the Prior Art

Cars are not only a conveyance means but also a personalized home in modern time. It is difficult for new cars to come out of a factory with the up-to-date electronic equipments because the car management laws stipulate that cars of new models have to first go through a series of tests and examinations and get security-certified before they are put on the market for sale. Therefore, many people would adapt their cars and add various accessories in order for the cars to be safer, more fancy and convenient, and comfortable to ride in.

When a person is installing an accessory on a car, he will have to find a suitable voltage of power supply of the car for the accessory, and connect the accessory to the power supply by means of power cords because there are several different voltages of power supplies in the car. Therefore, the following problems arise in installing an accessory to a car:

1. There are many power cords in a car to allow passage of different power voltages respectively, and in turn a person has to measure the voltage value of electric power to pass through each of the cords with a voltage measuring device in order to find a proper voltage for an accessory installed on the car. Therefore, the owner of a car can't install an accessory on the car by himself, and has to have professional persons install the accessory, and it will take relatively much labor and time to install an accessory on a car.

2. The appearance of a car will be spoiled by the cords connecting an accessory to the power supply if the accessory is installed on certain portions of a car such as the rear window.

Therefore, it is a main object of the present invention to provide a transfer-connecting device of a power supply of a vehicle to overcome the above problems.

### SUMMARY OF THE INVENTION

A power transfer-connecting device according to an embodiment of the present invention has several sockets at one end, several first terminals at the other end, and several second terminals. The transfer-connecting device is connected to a power supply and a lamp of a vehicle at two ends thereof. The power supply supplies several different voltages through separate power cords. A connecting component is connected to the power cords and the socket of the transfer-connecting device. The lamp has several terminals, which are connected to the first terminals respectively. The second terminals of the transfer-connecting device serve as output passages for the different voltages respectively, which are inputted into the transfer-connecting device through the connecting component; the second terminals are each denoted with a voltage value of electric power to pass through it. Therefore, when a person is installing an accessory on the vehicle, he can easily and rapidly connect the accessory to a correct one of the second terminals of the transfer-connecting device; the driver of the vehicle can install the accessory correctly by himself, and safely, easily, and rapidly.

The transfer-connecting device further has a wireless controller fitted thereon, which will be activated at the same time as the lamp. And, the accessory has a wireless receiver fitted thereon to receive signals from the wireless controller; thus, the accessory can be controlled in a wireless manner.

### BRIEF DESCRIPTION OF THE DRAWINGS

The present invention will be better understood by referring to the accompanying drawings, wherein:

FIG. 1 is an exploded perspective view of a connecting structure of a power supply and a lamp with the transfer-connecting device of the invention,

FIG. 2 is a view of the transfer-connecting device of the present invention in use,

FIG. 3 is an exploded perspective view of a connecting structure of a power supply and a lamp with a second embodiment of the invention,

FIG. 4 is a view of the second embodiment of the invention in use.

### DETAILED DESCRIPTION OF THE PREFERRED EMBODIMENTS

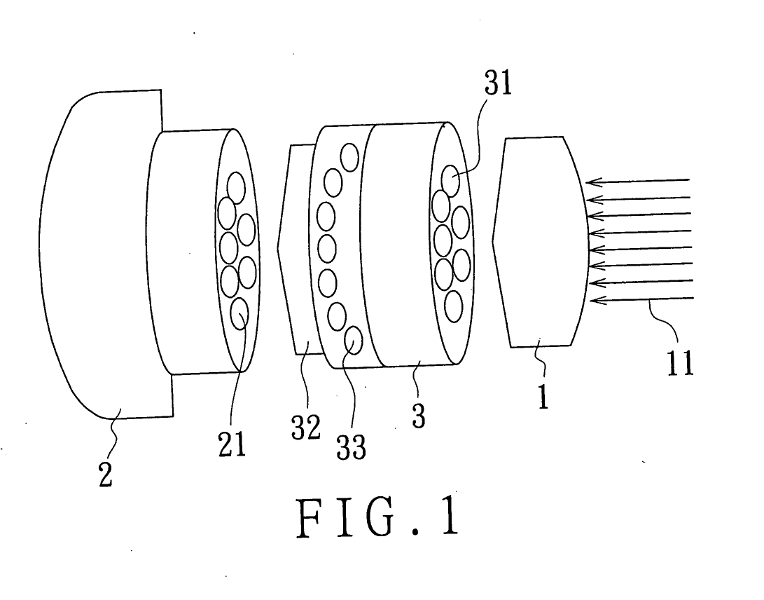

Shown in FIG. 1 is a connecting structure of a power supply and a lamp of a vehicle with a transfer-connecting device 3 of the present invention. The transfer-connecting device 3 is interposed between a power supply and a lamp 2 of a vehicle.

The power supply of the vehicle supplies several different voltages. The power supply has a connecting component 1, and several power cords 11 connected to the connecting component 1 to allow passage of the different voltages respectively.

The lamp 2 of the vehicle has several terminals 21 connected thereto. The transfer-connecting device 3 has several sockets 31 at one end thereof, which are connected to the connecting component 1 of the power supply. The transfer-connecting device 3 has several first terminals 32 at the other end, which are connected to the terminals 21 of the lamp 2 respectively. The transfer-connecting device 3 further has several second terminals 33, which will serve as output passages for the different voltages from the power supply respectively after the different voltages have been inputted into the transfer-connecting device 3 through the connecting component 1; thus, accessories of the vehicle can be connected to the second terminals 33 of the transfer-connecting device 3. The second terminals 33 are each denoted with a voltage value of electric power to pass through it.

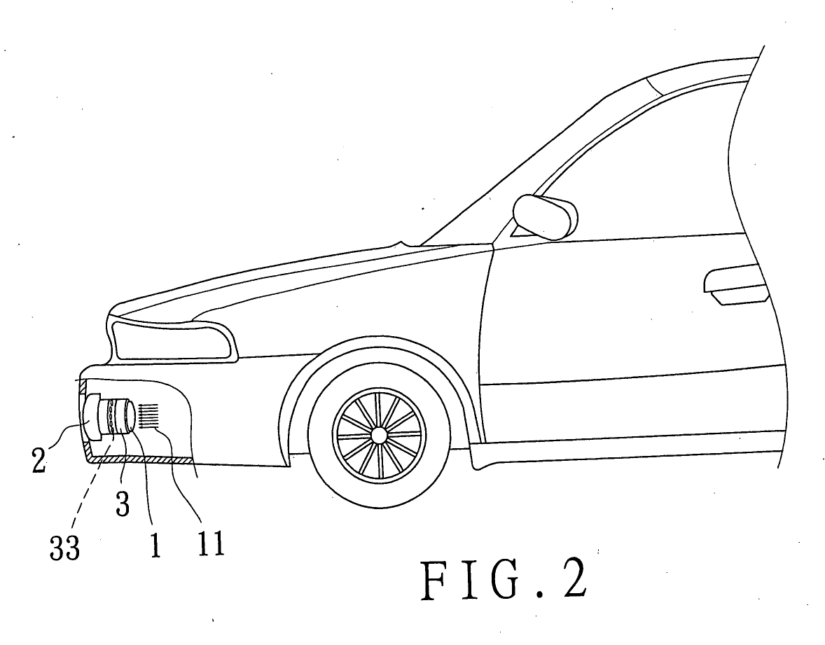

Referring to FIG. 2, the transfer-connecting device 3 is interposed between the lamp 2 and the connecting component 1 of the power supply, with the sockets 31 being connected to the connecting component 1, and the first terminals 32 being each connected to a respective one of the terminals 21 of the lamp 2. In use, power can be supplied from the power supply to the lamp 2 via the transfer-connecting device 3. When a person is installing an accessory on the vehicle, he can easily and rapidly connect the accessory to a correct one of the second terminals 33 of the transfer-connecting device 3 because the second terminals 33 are each denoted with a voltage value of electric power to pass through it. Consequently, the accessory will be powered with a proper voltage. In other words, owing to the transfer-connecting device 3 of the present invention, the driver of the vehicle can install the accessory correctly by himself, and safely, easily, and rapidly.

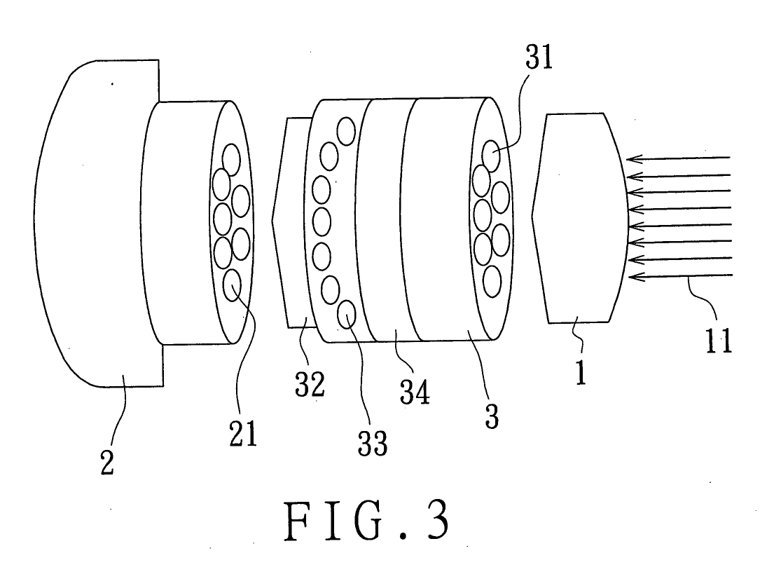

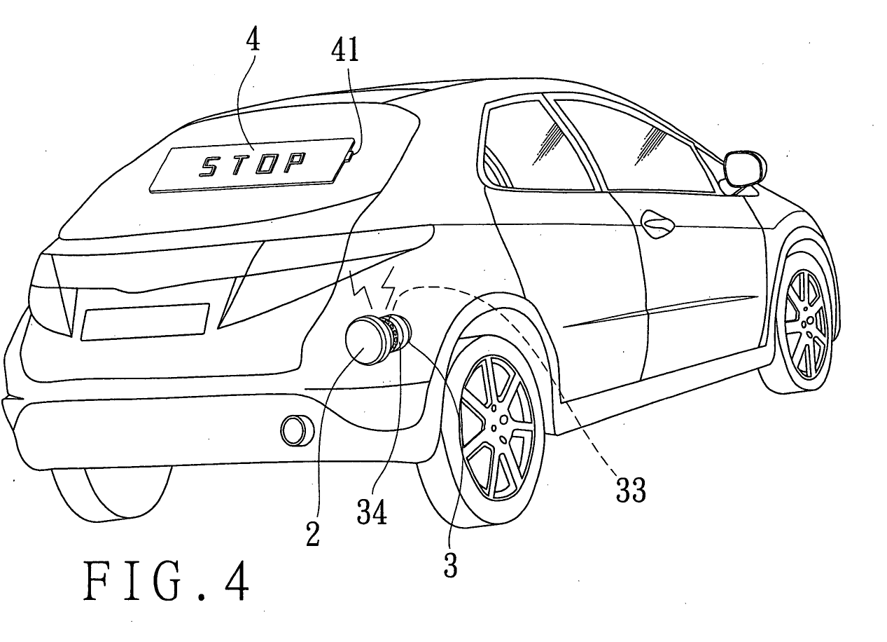

Shown in FIG. 3 is a connecting structure of a power supply and a lamp of a vehicle with another preferred embodiment 3 of a transfer-connecting device of the invention. The second preferred embodiment is basically the same as the first one, yet it has a wireless controller 34 fitted thereon. Referring to FIG. 4 as well, the vehicle has an accessory 4 installed thereon, and a wireless receiver 41 is fitted on the accessory 4 to receive signals sent out from the wireless controller 34. The wireless controller 34 and the lamp 2 of the vehicle are synchronized; when the driver turns on the lamp 2, the wireless controller 34 will send a signal to the wireless receiver 41 at the same time, thus making the accessory 4 start functioning. Because of the present transfer-connecting device, there won't be any connecting cord showing to spoil the look of the vehicle even if an accessory is installed on certain portions of the vehicle such as the rear window.

From the above description, it can be seen that the present invention has the following advantages:

1. When a person is installing an accessory on the vehicle, he can easily and rapidly connect the accessory to a correct one of the second terminals of the transfer-connecting device because the second terminals are each denoted with a voltage value of electric power to pass through it; owing to the transfer-connecting device of the present invention, the driver of the vehicle can install the accessory correctly by himself, safely, easily, and rapidly.

2. A wireless controller is fitted on the transfer-connecting device of the present invention, and an accessory of a vehicle is equipped with a wireless receiver to receive signals sent out from the wireless controller. Therefore, when the driver turns on the lamp, the wireless controller will send a signal to the wireless receiver at the same time, thus making the accessory start functioning; because of the present transfer-connecting device with the wireless controller and the wireless receiver, there won't be a problem of the appearance of the vehicle being going to be spoiled by cords if an accessory is installed on the rear window of the vehicle.

What is claimed is:

1. A transfer-connecting device of a power supply of a vehicle,
the transfer-connecting device being interposed between a power supply and a lamp of a vehicle;
the power supply of the vehicle supplying a plurality of different voltages; the power supply having a plurality of power cords to allow passage of said different voltages respectively; the power cords being connected to a connecting component;
the lamp of the vehicle having a plurality of terminals connected thereto;
the transfer-connecting device having at one end thereof a plurality of sockets, which are connected to the connecting component connected to the power cords of the power supply for said different voltages to be inputted into the transfer-connecting device through the connecting component;
the transfer-connecting device having at other end thereof a plurality of first terminals to be connected to the terminals of the lamp;
the transfer-connecting device having a plurality of second terminals to serve as output passages for said different voltages respectively.

2. The transfer-connecting device of a power supply of a vehicle as claimed in claim 1 further having a wireless controller fitted thereon;
the wireless controller and the lamp being going to be activated at a same time;
the vehicle having an accessory, which has a wireless receiver fitted thereon to be used together with the wireless controller.
